(19) United States
(12) Patent Application Publication
(10) Pub. No.: US 2010/0325556 A1
(43) Pub. Date: Dec. 23, 2010

(54) METHOD AND DEVICE FOR MODIFYING A PERSONAL DATA REPOSITORY IN A NETWORK

(75) Inventor: Zhongwen Zhu, Saint-Laurent (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/487,956

(22) Filed: Jun. 19, 2009

(51) Int. Cl. G06F 3/00; G06F 17/30; G06F 15/16

(52) U.S. Cl. 715/747; 707/621; 709/207; 707/781; 707/E17.007; 707/E17.005; 707/E17.032

(57) ABSTRACT

Method and nodes for modifying a personal data repository in a network comprise: based upon an end user inputs, receiving a modification request related to at least one data entry of the personal data repository, the at least one data entry having at least one device identifier associated thereto, each device identifier indicating a plurality of local devices that store the at least one data entry; and based upon further inputs of the end user, receiving a decision to modify the at least one data entry of the personal data repository in at least one of the plurality of local devices. Furthermore, method and nodes for data synchronization in the network comprise: receiving a modification request of the personal data repository of the network, the modification request including at least one data entry associated to at least one device identifier, each device identifier indicating a plurality of local devices in which a corresponding data entry needs to be modified

### TECHNICAL FIELD

The present invention generally relates to communication networks. More specifically, the present invention is concerned with a method and device for modifying a personal data repository in a communication network.

### BACKGROUND

Nowadays, it is common for individuals to own multiple devices which can manage their personal communications and store personal information. For example, a person can own a mobile phone, a Personal Digital Assistant (PDA), a personal computer at work and/or at home, etc. Each of these devices can offer personal data repositories, such as schedules for planning activities, contact lists, address books, task lists, calendars, personal notes, memos, other data storage, etc. Thus, individuals now rely heavily on those devices for providing personal data management, for example.

However, because of the multiple devices which are so available to the individuals, a great amount of personal data is distributed across the multiple devices and problems or inconsistencies may arise, especially when the same data information is stored in more than one device for example. Because of the data overlap between the different devices, a modification or update of the data information can lead to inconsistencies, when the modification or update is not carried out in all the devices that contain the data information. For example, a phone number of a person X can be stored in a mobile phone and in a personal computer of an end user. Later on, the person X calls the mobile phone of the end user to announce a change in the phone number. The mobile phone can be updated right away with the new phone number, but the end user may forget to make the change on his/her personal computer. Thus, data synchronization is an important aspect in such cases.

Each device that is connected to a network is referred to as a local device. Each local device then has a local personal data repository. The network also comprises a personal data repository which centralizes in the network all the local personal data repositories of the local devices being connected to the network. Thus, the personal data repository of the network comprises a master copy of all the local personal data repositories.

Data synchronization allows for synchronizing data across the different local devices and the network. Data synchronization can be carried out by several technologies, such as SyncML and SIP for example.

However, with the current data synchronization technologies, the end user, using a current local device, can only modify the portion of the network's personal data repository that represents the local personal data repository of the current local device. Since each local device has a limited view of the personal data repository of the network, when deleting data information that is shared with another device, the other device may be affected without the end user being aware of this problem.

Also, if there is no overlap of information between a first and second local devices, the first local device cannot be used for updating the portion of the personal data repository of the network repository representing the local personal data repository of the second local device and vice-versa.

Thus, as it can be seen, current methods of data synchronization between the local personal data repositories and the personal data repository of the network are limited. The present invention aims at providing a solution that would enhance data synchronization in a multi-device environment.

### SUMMARY

More specifically, in accordance with a first aspect of the present invention, there is provided a method a method for modifying a personal data repository in a network. The method comprises the step of: based upon an end user inputs, receiving a modification request related to at least one data entry of the personal data repository, the at least one data entry having at least one device identifier associated thereto, each device identifier indicating a plurality of local devices that store the at least one data entry. The method also comprises the step of: based upon further inputs of the end user, receiving a decision to modify the at least one data entry of the personal data repository in at least one of the plurality of local devices

According to a second aspect of the present invention, there is provided a mobile node connected to a network having a personal data repository. The mobile node comprises an input interface for receiving: a modification request related to at least one data entry of the personal data repository of the network, the at least one data entry having at least one device identifier associated thereto, each device identifier indicating a plurality local devices that store the at least one data entry; and a decision to modify the at least one data entry of the personal data repository in at least one of the plurality of local devices.

According to a third aspect of the present invention, there is provided a method for data synchronization between a personal data repository in a network and a plurality of local personal data repositories. The method comprises the step of: receiving a modification request of the personal data repository of the network, the modification request including at least one data entry associated to at least one device identifier, each device identifier indicating a plurality of local devices in which a corresponding data entry needs to be modified.

According to a fourth aspect of the present invention, there is provided a server node for data synchronization between a personal data repository of a network and a plurality of local personal data repositories. The server node comprises: an input interface for receiving a modification of the personal data repository of the network, the modification request including at least one data entry associated to at least one device identifier, each device identifier indicating a plurality of local devices in which a corresponding data entry needs to be changed.

According to a fifth aspect of the present invention, there is provided a personal data repository of a network which comprises: data entries from local personal data repository of local devices connected to the network; and a device identifier associated to each data entry of the personal data repository. The device identifier allows an end user to determine which local devices are affected by a modification in at least one data entry of the personal data repository

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic view of a network for data modification and synchronization in a multi-device environment;

FIG. 2 illustrates an exemplary personal data repository in the network of FIG. 1 according to a non-restrictive illustrative embodiment of the present invention;

FIG. 3 is a flow chart illustrating a method for modifying the personal data repository of FIG. 2;

FIG. 4 is a flow chart illustrating a method for data synchronization in the network of FIG. 1;

FIG. 5 is a flow chart illustrating a detailed method for modifying the personal data repository;

FIG. 6 is a flow chart illustrating a detailed method for data synchronization;

FIG. 7 is a schematic view of a local device or a mobile node according to a non-restrictive illustrative embodiment of the present invention; and

FIG. 8 is a schematic view of a server or a server node according to a non-restrictive illustrative embodiment of the present invention.

### DETAILED DESCRIPTION

Generally stated, non-restrictive illustrative embodiments of the present invention allow an end user having multiple devices connected to a network to modify the personal data repository of the network using any of the multiple devices. They also allow the end user to see the impacts on the multiple devices of an update or modification in at least one data entry of the personal data repository of the network. To do so, a device identifier, for identifying each of the multiple devices, is attached/associated to each data entry of the personal data repository of the network so as to identify which devices it belongs to. Thus, through the use of the device identifier, the end user can also fetch data entries that don't belong to the currently used local device. Once the data entries in the personal data repository of the network are modified, the modified data entries will be synchronized in the corresponding affected local devices.

It should be noted that the personal data repository comprises personal data that belong or are useful to an end user. Those personal data are not necessarily data concerning the end user himself or herself but they comprise data that the end user wishes to keep, such as address book information, contact lists, scheduling, personal notes, calendars, etc.

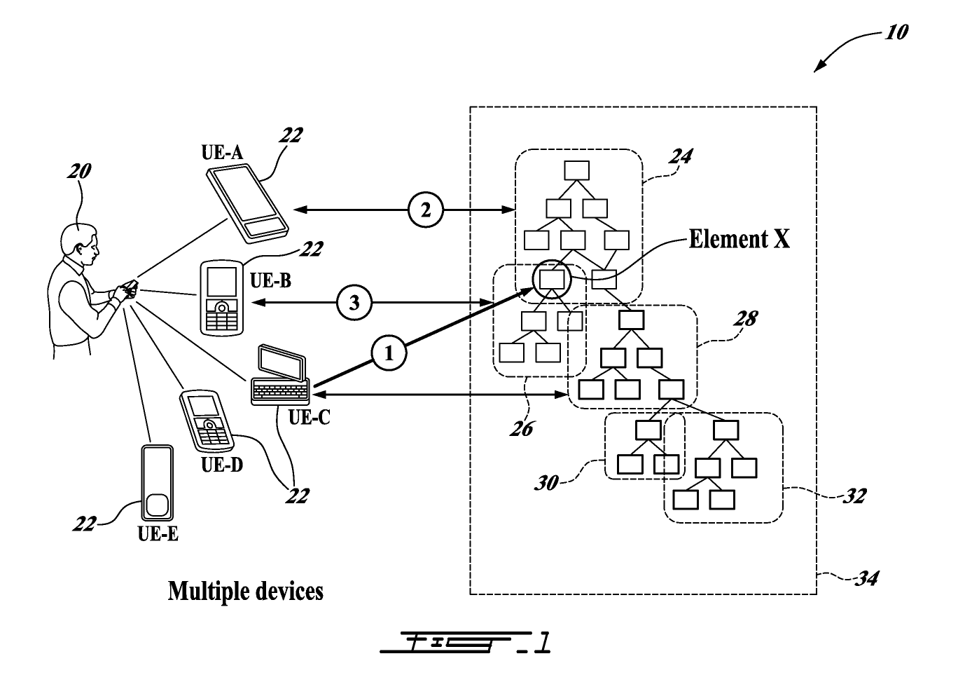

Now turning to FIG. 1, a network 10 for data synchronization in a multi-device environment will be described.

An end user 20 owns a plurality of local devices also called User Equipments (UE) 22, for example, UE-A to UE-E, in which he/she can store information and which are connected to the network 10. The plurality of local devices 22 can be a mobile phone, a PDA, a smart phone, etc. Each of the local devices 22 comprises a local personal data repository (not shown). A copy of each local personal data repository is stored by the network 10, more specifically in a database of a server (not shown) in the network 10, so as to form the personal data repository 34 of the network 10. The local personal data repository of the local device 22 UE-A is shown as the portion 24 of the personal data repository 34 of the network 10, the local personal data repository of the local device 22 UE-B corresponds to the portion 26, the local personal data repository of the local device 22 UE-C to the portion 28, the local personal data repository of the local device 22 UE-D to the portion 30, and the local personal data repository of the local device 22 UE-E to the portion 32 of the personal data repository 34 of the network 10.

It should be noted that the local personal data repository 24 of the local device 22 UE-A and the local personal data repository 26 of the device 22 UE-B have an overlapping element X or data entry. A data entry can be for example a contact or address information or any other information stored by the end user 20 in one of his/her local devices 22.

As mentioned earlier, if the end user 20 uses the local device 22 UE-A to update the personal data repository 34 of the network 10, only the portion 24 will be updated. The rest of the personal data repository 34 of the network 10 cannot be changed by the local device 22 UE-A, since each local device 22 can have access only to its own portion of the personal data repository 34. However, if an element is overlapping between two or more local personal data repositories, such as element X and if the local device UE-A 22 decides to modify the element X, it cannot know that the local personal data repository of the local device 22 UE-C will be also affected. Embodiments of the present invention allow for overcoming these drawbacks.

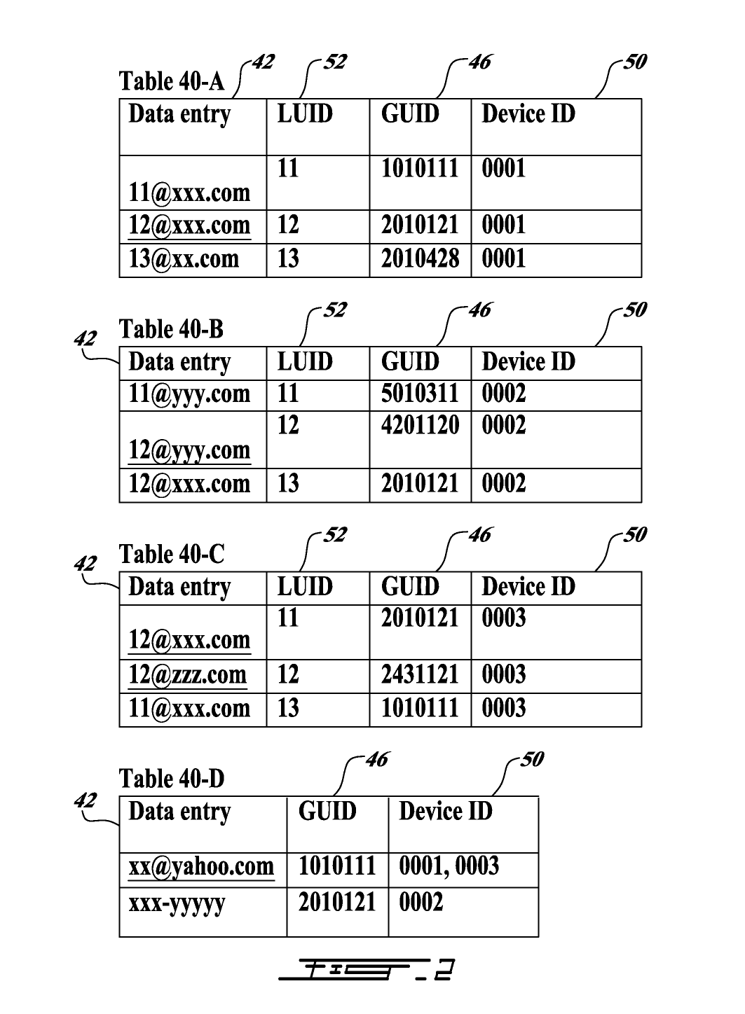

Turning now to FIG. 2, an example of the data structure of the personal data repository 34 of the network 10, according to a non-restrictive illustrative embodiment of the present invention will be described.

In this example, it is supposed that the end user 20 has three local devices connected to the network 10. The personal data repository 34 comprises for example a number of tables 40 corresponding to the number of local devices 22. In FIG. 2, three tables 40 (A, B and C) corresponding to the three local devices 22 are illustrated. Each table 40 comprises a plurality of data entries 42. Each data entry 42 is associated with a Global Unique Identifier (GUID) 46. The GUID 46 can be a label, a tag or any indicator for identifying each data stored in the personal data repository 34. Optionally, each data entry 42 of the tables 40 can also be associated with a Local Unique Identifier (LUID) 52. Indeed, each data entry stored in a local device 22 has a local label, corresponding to the LUID 52. A server (not shown) can do the mapping between the GUID 46 and the LUID 52. For example, a same LUID 52 can be re-used within different local devices. The GUID 46 allows for maintaining the uniqueness of the data entry 42.

Furthermore, for each data entry 42 in the tables 40, there is a device identifier (or device ID) 50 attached/associated thereto. The device ID 50 allows for identifying each local device 22 to which the data entry 42 belongs. Thus, when the end user 20 wishes to make a modification in at least one data entry 42 in the personal data repository 34, he/she can know which local device 22 will be affected by that modification through the device ID 50 (e.g., the device ID 50 is meaningful to the end user 20 or the device ID 50 is used to retrieve a name that is meaningful to the end user 20). The device identifier 50 can be a label, a tag or any other identifiers/indicators for the purposes of identification.

Indeed, for example, as shown in table 40-D, when the end user 20 wishes to modify the data entry 42 having the GUID 1010111 and the data entry 42 having the GUID 2010121, the personal data repository 34 sends the table 40-D to the end user 20 upon a modification request from the end user 20. For the first data entry 42 having the GUID 1010111 in table 40-D, the device ID 50 identifies two local devices, such as local devices 0001 and 0003. For the second data entry 42 of table 40-D, the device ID 50 identifies one local device 0002. By looking at the table 40-D or using the data contained therein to obtain more meaningful information, the end user 20 can know which local devices 20 would be affected by any changes that occur for these 2 data entries.

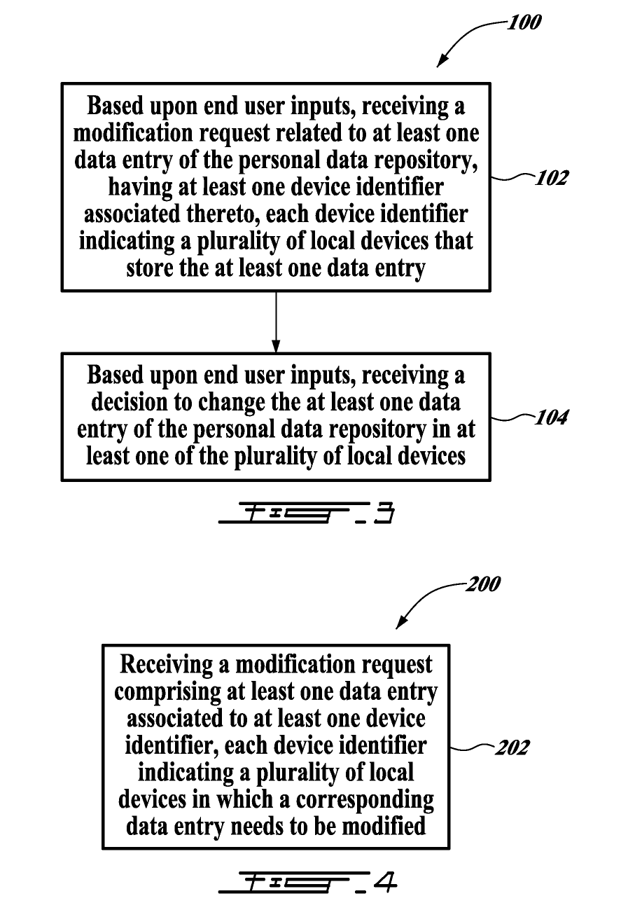

Now turning to FIG. 3 and with reference to FIGS. 1 and 2, a method 100 for modifying the personal data repository 34 in the network 10 will be described.

When the end user 20 wishes to modify the personal data repository 34, using the local device 22 UE-A for example, the local device 22 UE-A receives from the end user 20 a modification request related to at least one data entry of the personal data repository 34 (step 102). The modification request can be to add, remove/delete or update the at least one data entry. Furthermore, the at least one data entry comprises at least one device identifier 50 associated thereto, each device identifier indicating a plurality of local devices 22 that stores the at least one data entry, as shown in FIG. 2.

In step 104, based upon the end user 20 inputs (after he/she has decided which data entry of the personal data repository 34 to modify and the content of the corresponding modification, for example), the local device 22 UE-A receives a decision to modify the at least one data entry in at least one of the plurality of local devices 22.

More specifically, after the local device 22 UE-A receives the modification request related to the at least one data entry, it forwards this request to the personal data repository 34 in order to fetch the at least one data entry. Upon receipt of the modification request, the personal data repository 34 sends a response back to the local device UE-A 22, the response being similar to the table 40-D of FIG. 2, i.e. the requested at least one data entry is associated with at least one device identifier 50.

In order to identify the at least one data entry that the end user 20 wishes to modify, he/she can enter, for example, a name or any other piece of information corresponding to the at least one data entry in the request and capable of being used in a lookup. If the end user 20 does not know which data entry to modify exactly, he/she can request a copy of the whole personal data repository 34. Once the local device 22 UE-A receives the at least one data entry or the whole personal data repository 34, the end user 20 can determine which ones of the local devices 22 will be affected by a modification in the at least one data entry through the device identifier 50, which indicates at least one local device 22 storing the requested at least one data entry. The device identifier 50 allows the end user 20 to avoid modifying important information, which belongs to another local device 22, using a currently local device 22 (UE-A), for example.

After the local device 22 UE-A receives a decision to modify, along with the modification, from the end user 20 inputs, it forwards the decision to modify and the modification to the personal data repository 34 in a further modification request. Once the personal data repository 34 receives the request, it performs the modification. For example, the phone number in the at least one data entry can be changed. After the modification, the personal data repository 34 sends a notification for data synchronization to the local devices 22 identified by the device ID 50. Then, data synchronization process among the local devices 22 identified by the device ID 50 is performed. The process is illustrated in FIG. 4.

Turning to FIG. 4, method 200 for data synchronization in a multi-device environment between the personal data repository 34 and the plurality of local personal data repositories will be described now.

Method 200 starts with step 202 in which the personal data repository 34 receives the further modification request. The request comprises at least one data entry of the personal data repository 34, its corresponding modification, and at least one device identifier associated thereto, each device identifier indicating a plurality of devices in which a corresponding data entry needs to be changed. The modification can comprise addition, removal/deletion or update of the at least one data entry. For example, part of the request looks like table 40-D of FIG. 2, in which the data entry 42 contains the modification, i.e. the modified information, and the device ID 50 attached thereto.

More specifically, upon receiving the further modification request, the personal data repository 34 determines which local devices 22 are affected by the modification through the at least one device ID 50. Then the personal data repository 34 sends a data synchronization request or notification to the local devices 22 that have been determined to be affected by the received request of modification.

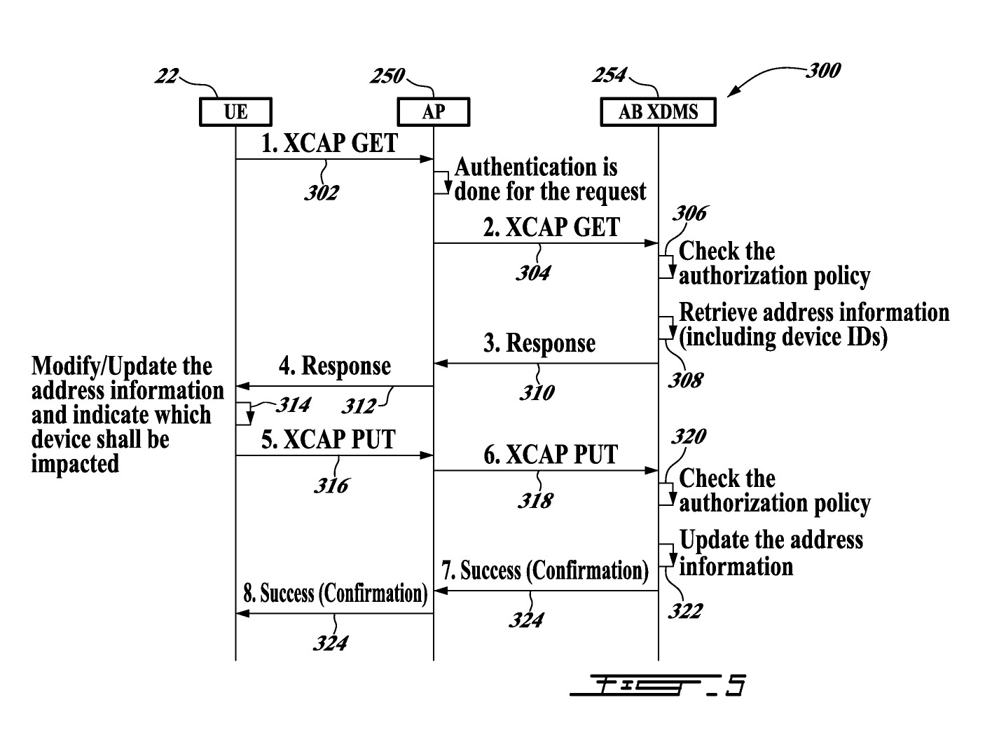

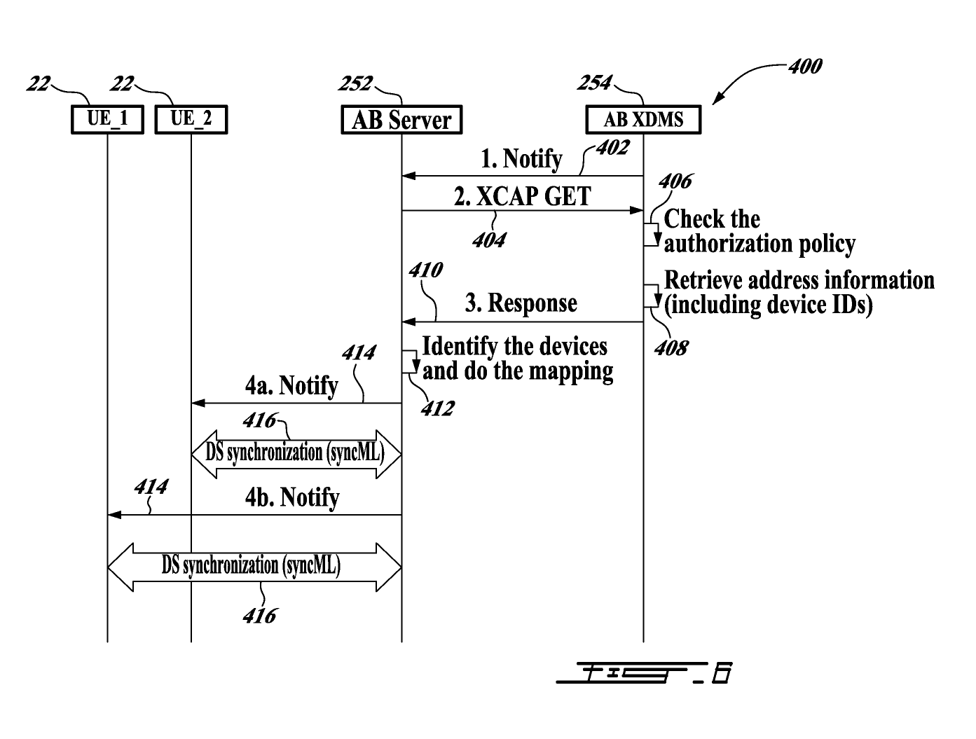

Now, methods 100 and 200 will be explained in more detail with reference to FIGS. 5 and 6 and in the context of a specific implementation example. However, methods 100 and 200 are not restricted to such an implementation example.

Indeed, methods 300 and 400 of FIGS. 5 and 6 respectively will be described in the context of a network such as 10, using a DS (Data Synchronization) client/server for synchronization purposes. The network 10 includes a DS client installed in the local devices 22 connected to the network 10, an aggregation proxy AP 250 for the purposes of authentication and authorization, a server 252 and a database containing a personal data repository referred to as an XML Data Management Server (XDMS) 254 and connected to the server 252.

Method 300 for modifying at least a portion of the XDMS 254 starts with step 302, where the end user 20 uses for example an XDM client on one of his/her local devices 22 (such as UE-A) to send an XCAP request (using XCAP GET) towards the AP 250 for requesting a modification in at least one data entry and to fetch the at least one data entry from the XDMS 254. It should be noted that other types of protocols can be also used.

In step 304, the AP 250 forwards the XCAP GET request to the XDMS 254 after validating the authentication and authorization policies of the end user 20.

In step 306, upon receiving the XCAP GET request, the XDMS 254 applies or checks the authorization policy to the end user 20. If the end user 20 is authorized, then, in step 308, the XDMS 254 retrieves the requested at least one data entry including at least one associated device ID 50 from the XDMS 254.

In step 310, the XDMS 254 sends a response to the AP 250 including the retrieved at least one data entry and the at least one device ID 50 associated thereto.

In step 312, the AP 250 forwards the response to the local device UE-A 22 of the end user 20.

In step 314, based upon the received response (including the at least one data entry and its associated device ID), the end user 20 makes a decision on which data entry to modify. At the same time, the end user 20 is also able to know which local devices 22 will be impacted by the modification. Indeed the local device 22 UE-A, for example, displays the device ID 50 or meaningful information to be obtained thereby on its screen so that the end user 20 can see which local devices 22 will be impacted by the modification.

After the decision is made, in step 316, the end user 20 of the local device UE-A 22 sends a new request, using XCAP PUT for example, to modify the XDMS 254 with the modified information, via the AP 250.

In step 318, the AP 250 receives the XCAP PUT request and forwards it to the XDMS 254.

In step 320, the XDMS 254 first checks to see if the end user 20 or the local device UE-A 22 is authorized to make the modification. If the authorization is done successfully, then, in step 322, the XDMS 254 modifies the XDMS 254 based upon the received modifications or applies the modifications.

In step 324, the XDMS 254 sends a confirmation back to the end user 20 informing him/her of a success or failure of the modification, via the AP 250.

The detailed method 400 for data synchronization between the XDMS 254 and the plurality of local personal data repositories is illustrated in FIG. 6.

Method 400 starts with step 402 where the XDMS 254, after being modified, sends a notification about the modification to the server 252.

In step 404, upon receipt of the notification, the server 252 issues an XCAP request to fetch the modified data entry from the XDMS 254.

In step 406, the XDMS 254 checks the XCAP request for authentication purposes. Once the authentication is validated, the XDMS 254 retrieves the modified data entry with its corresponding device ID 50 in step 408, which is then sent to the server 252 in step 410.

In step 412, the server 252 identifies each local device 22 that is impacted/affected by the modified data entry. Furthermore, the server 252 can also perform the mapping between a GUID and a Local Unique Identifier (LUID) for the modified at least one data entry. Indeed, each data entry stored in a local device 22 has a local label, called the LUID. And each data stored in the network has a global label, called the GUID. The server 252 performs such a mapping between the LUID and the GUID.

Once the affected devices 22 have been determined, the server 252 sends to each one of the affected local devices 22 a notification for data synchronization in step 414.

Then in step 416, data synchronization is performed using SyncML or SIP or any other synchronization protocols. The modification is applied to the at least one data entry in the corresponding local devices 22.

For example, in FIG. 6, two local devices UE_1 and UE_2 have been determined as to be affected by the modification in the at least one data entry. Thus, each one of them receives a notification and then data synchronization is performed successively, for example, by making the modification in each one of the affected local devices 22.

It is believed that the data synchronization is well-known in the art and thus will not be described further.

In the following, the case where the end user 20 decides to modify a data entry only in one local device (for example UE-C), even though the device ID 50 associated to the data entry indicates two local devices 22 (UE-A and UE-C for example), will be described.

The end user's input indicates such a modification request, which is then sent to the XDMS 254. When the XDMS receives the modification request, it will keep track on all the modifications made on the same data entry with different values using “a history file” for example. More specifically, the XDMS 254 handles the modification request as follows:
The data entry in the XDMS 254 remains the same for the local device 22 UE-A. For instance, Alice's email address is “alice@gmail.com” for the local device 22 UE-A.
Then, a special flag is set up to identify this data entry, which has different values across different local devices, e.g. device 22 UE-A and device 22 UE-C.
Also, a link is provided to the corresponding data entry in the history file that keeps track of the operations performed by the XDMS 254.
In the history file, the different values in the different local devices 22 for a same data entry are specified. For example, the history file can specify that Alice's email address in local device 22 UE-C is set to “alice@yahoo.com”.
Eventually, when the end user 20 decides to have the same value for the same data entry on both of the local devices 22 (UE-A and UE-C), e.g. alice@yahoo.com, the data entry in the XDMS 254 is updated and the record in the history file is cleaned up.

It should be noted that other implementations of this case are possible. For example, an alternative can be to create a sub-element under the device ID 50 for the content of the data entry, to yield, e.g.:

GUID→Data entry->Device ID→content

Now, the case where the modification comprises a removal/deletion will be described. Based upon the device ID 50, the server 254 creates a special object to be synchronized between the local devices 22 identified by the device ID 50 and the server 254. The data entry to be deleted will appear as an empty element or attribute in the created object for synchronization. After the synchronization is done, the identified local devices 22 shall delete the corresponding element or attribute in their local devices 22.

It should be noted that the network 10 can use technologies other than the DS client/server. For example, SIP client can be also used. In this case, protocols such as SIP SUBSCRIBE and SIP NOTIFY are used for requesting and receiving modified data entries of the personal data repository 34 of the network 10. Also, in this case, there is no need of the server 252. The local devices 22 communicate directly with the personal data repository 34 or the XDMS 254. Of course, a person skilled in the art would understand that traffic flows can vary according to the different technology implementations.

In a further embodiment of the present invention, the server 252 comprises an address book server (AB server) and the XDMS 254 comprises an address book XML Data Management Server (AB XDMS).

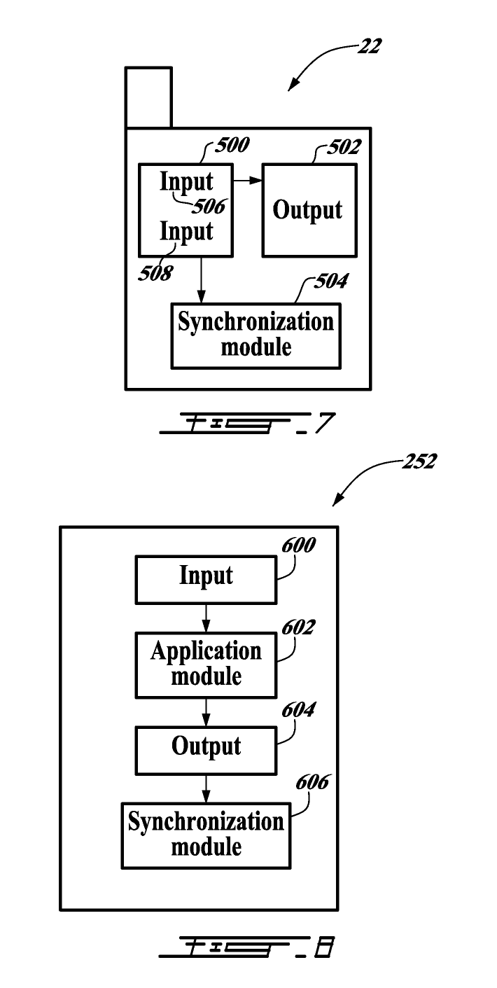

FIG. 7 illustrates a schematic view of a local device 22, which can be also referred to as a mobile node, for modifying the personal data repository 34 in the network 10.

The local device 22 comprises an input interface 500, an output 502 and a synchronization module 504. Of course the local device 22 also comprises a plurality of other components (not shown), such as a processor or memory, for performing its usual tasks and procedures, which are well known in the art and thus will not be described further.

The input 500 interface can comprise a first input interface 506 and a second input interface 508. The first input interface 506 can receive, for example, a modification request related to at least one data entry of the personal data repository 34, based on the end user 20 inputs. The at least one data entry has at least one device identifier associated thereto, each device identifier indicating at least one local device that stores the at least one data entry. The second input interface 508 can receive, based upon the end user 20 inputs, a decision to modify the at least one data entry of the personal data repository 34 in the at least one local device 22. It should be understood that the first and second inputs 506 and 508 can be merged into a single input interface such as 500.

The output interface 504 is connected to the input interface 500. Upon receiving the decision to modify, the output interface 504 forwards the decision to modify to the personal data repository 34, in a modification request. The modification request may also comprise the modification to be performed in the personal data repository 34 related to the at least one data entry.

Furthermore, the input interface 500 also receives a notification for synchronization from the personal data repository 34, once the personal data repository 34 has performed the modification in the at least one data entry.

The synchronization module 504 allows to modify and synchronize the local personal data repositories with the at least one modified data entry in the personal data repository 34, using, e.g., SIP, SyncML, etc.

FIG. 8 illustrates a server, such as 252 (or a server node) for data synchronization between the personal data repository 34 and a plurality of local personal data repositories from the local devices 22. The server comprises an input interface 600, an application module 602, an output interface 604 and a synchronization module 606. The server node also comprises a plurality of other components (not shown), such as a processor or memory, for performing its usual tasks and procedures, which are well known in the art and thus will not be described further.

The input interface 600 receives a modification request from a local device 22. The modification request includes at least one data entry (with the modification) of the personal data repository, the at least one data entry associated to at least one device ID 50, each device ID 50 indicating at least one local device 22, in which a corresponding data entry needs to be modified.

Once the server 252 receives the modification request and the modification, the application module 602 applies the modification in the personal data repository 34 to the at least one data entry.

Also, the server 252 can comprise a mapping module (not shown) which allows for mapping between the LUID and the GUID of a data entry. For different local devices 22, a same LUID can be used. Of course, people skilled in the art would understand that other types of mapping between a local stored data and a global stored data could be used.

After the modification in the at least one data entry, the output interface 604 sends a data synchronization request to the at least one local given by the device ID 50 for synchronizing and performing the modification in their respective local personal data repositories.

The synchronization module 606, then, performs the modification and synchronization in the at least one data entry of the corresponding local devices 22.

Although the present invention has been described in the foregoing specification by means of a non-restrictive illustrative embodiment, this illustrative embodiment can be modified at will within the scope, spirit and nature of the subject invention.

What is claimed is:

1. A method for modifying a personal data repository in a network, the method comprising the steps of:
based upon an end user inputs, receiving a modification request related to at least one data entry of the personal data repository, the at least one data entry having at least one device identifier associated thereto, each device identifier indicating a plurality of local devices that store the at least one data entry; and
based upon further inputs of the end user, receiving a decision to modify the at least one data entry of the personal data repository in at least one of the plurality of local devices.

2. A method as defined in claim 1, wherein receiving the modification request and receiving the decision to modify comprise a modification selected from the group consisting of adding, removing and updating the at least one data entry of the personal data repository.

3. A method as defined in claim 1, further comprising sending the decision to modify to the personal data repository in a further modification request.

4. A method as defined in claim 1, further comprising receiving a data synchronization notification from the personal data repository.

5. A method as defined in claim 4, wherein, upon receiving the data synchronization notification, the data synchronization is performed.

6. A method as defined in claim 1, further comprising displaying the at least one device identifier to an end user.

7. A mobile node connected to a network having a personal data repository, the mobile node comprising:
an input interface for receiving:
a modification request related to at least one data entry of the personal data repository of the network, the at least one data entry having at least one device identifier associated thereto, each device identifier indicating a plurality local devices that store the at least one data entry; and
a decision to modify the at least one data entry of the personal data repository in at least one of the plurality of local devices.

8. A mobile node as defined in claim 7, wherein the modification request and the decision to modify are received in one single input.

9. A mobile node as defined in claim 7, further comprising an output interface for sending the decision to modify to the personal data repository in a further modification request.

10. A mobile node as defined in claim 8, wherein the single input further receives a notification for data synchronization.

11. A mobile node as defined in claim 10, further comprising a synchronization module for performing data synchronization upon reception of the notification.

12. A method for data synchronization between a personal data repository in a network and a plurality of local personal data repositories, the method comprising the step of:
receiving a modification request of the personal data repository of the network, the modification request including at least one data entry associated to at least one device identifier, each device identifier indicating a plurality of local devices in which a corresponding data entry needs to be modified.

13. A method for data synchronization as defined in claim 12, wherein the personal data repository of the network stores the plurality of local personal data repositories.

14. A method for data synchronization as defined in claim 12, wherein the modification request comprises a modification selected from the group consisting of adding, removing and updating the at least one data entry.

15. A method for data synchronization as defined in claim 14, further comprising, in response to the modification request, applying the modification to the at least one data entry.

16. A method for data synchronization as defined in claim 15, further comprising sending a data synchronization notification to the at least one local device.

17. A method for data synchronization as defined in claim 16, further comprising applying the modification in the at least one local device.

18. A method for data synchronization as defined in claim 12, further comprising checking authorization policies of the received modification request.

19. A server node for data synchronization between a personal data repository of a network and a plurality of local personal data repositories, the server node comprising:
an input interface for receiving a modification of the personal data repository of the network, the modification request including at least one data entry associated to at least one device identifier, each device identifier indicating a plurality of local devices in which a corresponding data entry needs to be changed.

20. A server node as defined in claim 19, wherein the personal data repository of a network stores the plurality of local personal data repositories.

21. A server node as defined in claim 19, wherein the received modification request comprises a modification selected from the group consisting of adding, removing and updating the at least one data entry.

22. A server node as defined in claim 21, further comprising an application module, for applying the modification in the at least one data entry, in response to the received modification request.

23. A server node as defined in claim 19, further comprising an output interface for sending a data synchronization notification to the at least one local device.

24. A server node as defined in claim 23, further comprising a synchronization module for applying the modification in the at least one local device.

25. A personal data repository of a network comprising:
data entries from local personal data repository of local devices connected to the network; and
a device identifier associated to each data entry of the personal data repository;
wherein the device identifier allows an end user to determine which local devices are affected by a modification in at least one data entry of the personal data repository.
